(19) United States
(12) Patent Application Publication
(10) Pub. No.: US 2015/0247381 A1
(43) Pub. Date: Sep. 3, 2015

(54) SYSTEMS AND METHODS FOR COUPLING ACOUSTIC AND/OR ULTRASONIC ENERGY TO A FLUID STREAM COMPRISING AN EMULSION OR A MICROEMULSION TO ENHANCE PRODUCTION OF HYDROCARBONS FROM OIL AND/OR GAS WELLS

(71) Applicant: CESI Chemical, Inc., Houston, TX (US)

(72) Inventor: John T. Pursley, Highlands Ranch, CO (US)

(73) Assignee: CESI Chemical, Inc., Houston, TX (US)

(21) Appl. No.: 14/633,247

(22) Filed: Feb. 27, 2015

Related U.S. Application Data
(60) Provisional application No. 61/946,130, filed on Feb. 28, 2014.

(51) Int. Cl. E21B 37/06; E21B 43/16; C09K 8/58

(52) U.S. Cl. CPC E21B 37/06; C09K 8/58; E21B 43/16

(57) ABSTRACT

Systems and methods for enhancing production of hydrocarbons from oil and/or gas wells are generally described. In some cases, an oil and/or gas well may contain deposits of impurities (e.g., scale, migrating fines, paraffin, and/or asphaltenes) that obstruct the flow of fluid through the well and thereby limit the recovery of hydrocarbons from the well. A method of enhancing oil and/or gas recovery from such a well may comprise coupling acoustic and/or ultrasonic energy to a fluid stream comprising an emulsion or a microemulsion being injected into the well. The coupled flow of an emulsion or a microemulsion may cause the deposits to break up and be removed from the well, thus enhancing fluid flow through the well and increasing the productivity of the well.

### RELATED APPLICATIONS

This application claims priority to U.S. Provisional Application No. 61/946,130, filed Feb. 28, 2014, which is incorporated herein by reference in its entirety.

### FIELD OF INVENTION

The present invention generally provides systems and methods for enhancing the production of hydrocarbons from oil and/or gas wells and, in particular, for coupling acoustic and/or ultrasonic energy to a fluid stream comprising an emulsion or a microemulsion.

### BACKGROUND OF INVENTION

Desirable hydrocarbons such as crude oil and natural gas are generally recovered from subterranean formations through the use of oil and/or gas wells that are drilled through the surface of the Earth. Throughout the life cycle of an oil and/or gas well, production of crude oil and/or natural gas may be reduced due to blockage of the well. For example, scale (e.g., inorganic salts that precipitate from formation water), migrating fines (e.g., fine particles of clay or quartz that migrate towards the wellbore), paraffin (e.g., wax that precipitates from crude oil), and/or asphaltenes (e.g., molecular impurities found in crude oil) may accumulate and obstruct fluid flow through the wellbore. Thus, there is a need for effective systems and methods for removing deposits of impurities in an oil and/or gas well to restore and/or increase productivity of the well.

### SUMMARY OF INVENTION

The present invention generally provides systems and methods for enhancing the production of hydrocarbons from oil and/or gas wells and, in particular, for coupling acoustic and/or ultrasonic energy to a fluid stream comprising an emulsion or a microemulsion. The subject matter of the present invention involves, in some cases, interrelated products, alternative solutions to a particular problem, and/or a plurality of different uses of one or more systems and/or articles.

In some embodiments, methods are provided comprising coupling acoustic and/or ultrasonic energy to a fluid stream being injected into an oil and/or gas well, wherein the fluid stream comprises an emulsion or a microemulsion.

Other aspects, embodiments, and features of the invention will become apparent from the following detailed description when considered in conjunction with the accompanying drawings. All patent applications and patents incorporated herein by reference are incorporated by reference in their entirety. In case of conflict, the present specification, including definitions, will control.

### DETAILED DESCRIPTION

Systems and methods for enhancing the production of hydrocarbons from oil and/or gas wells are generally described. In some cases, a well (e.g., a wellbore) may contain deposits of impurities (e.g., scale, migrating fines, paraffin, and/or asphaltenes) that may obstruct the flow of fluid through the well and thereby limit the recovery of hydrocarbons from the well. A method of enhancing oil and/or gas recovery from such a well may comprise injecting a fluid stream into the well (e.g., wellbore). In some embodiments, acoustic and/or ultrasonic energy is coupled to the fluid stream. In some embodiments, the oscillating fluid stream comprises an emulsion or a microemulsion, as described in more detail herein. The emulsion or microemulsion may include water, a solvent, a surfactant, and optionally a freezing point depression agent or other components. In some embodiments, the flow of an oscillating fluid comprising an emulsion or a microemulsion may cause the deposits to break up and be removed from the well, thus enhancing fluid flow through the well and increasing the productivity of the well.

In some embodiments, the inventors have unexpectedly found that coupling acoustic and/or ultrasonic energy to a fluid stream comprising an emulsion or a microemulsion being injected into an oil and/or gas well can increase both immediate and long-term productivity of the well as compared to coupling acoustic and/or ultrasonic energy to a fluid stream that does not comprise an emulsion or a microemulsion. One of ordinary skill in the art would recognize that injecting a coupled fluid stream (e.g., a fluid stream that has been coupled to acoustic and/or ultrasonic energy) into a well (e.g., wellbore) may have some benefits. For example, the coupled fluid stream may result in cyclic loading of impurities deposited within the well, which may cause the impurities to disintegrate. The cyclic loading may, for example, comprise alternating compressive and tensile loading. In some cases, a coupled fluid stream may result in acoustic streaming (e.g., steady motion of a fluid induced by acoustic waves in the fluid), which may dislodge deposits from the walls of the well. In addition to these recognized benefits of injecting a coupled fluid stream, it has been found that injecting a coupled fluid stream comprising an emulsion or a microemulsion into an oil and/or gas well can further enhance the productivity of the well as compared to injection of a coupled fluid stream that does not comprise the emulsion or the microemulsion. For example, the acoustic and/or ultrasonic energy may add shear energy to the emulsion or microemulsion. In some cases, adding shear energy to the emulsion or microemulsion can increase and/or stabilize formation of the emulsion or microemulsion. In some cases, adding shear energy to the emulsion or microemulsion can further reduce the size of emulsion or microemulsion droplets. It may be beneficial, for example, for droplet size to be reduced, to increase thermodynamic and/or kinetic stability, increase clarity of the emulsion and/or microemulsion, and/or reduce interfacial tension. In some embodiments, the acoustic and/or ultrasonic energy may act on the emulsion or microemulsion to favorably increase its interaction with the wellbore. In some embodiments, the acoustic and/or ultrasonic energy may act on the interface between the emulsion or microemulsion and the wellbore. In some such embodiments, the effectiveness of the emulsion or microemulsion in enhancing productivity of the oil and/or gas well may be increased.

As used herein, a “coupled fluid stream” refers to a fluid stream that has been coupled to acoustic and/or ultrasonic energy. The term “acoustic energy” generally refers to energy transmitted by waves having a frequency within the range of about 20 Hz to about 20 kHz. The term “ultrasonic energy” generally refers to energy transmitted by waves having a frequency greater than about 20 kHz. Acoustic and/or ultrasonic energy may be coupled to a fluid stream by transmitting acoustic and/or ultrasonic waves to the fluid stream through any transmission medium, as described in more detail herein.

Some embodiments relate to a fluid comprising an emulsion or a microemulsion being injected into an oil and/or gas well. In some embodiments, the oil and/or gas well comprises bulk fluid. The bulk fluid may comprise, for example, formation fluids (e.g., naturally occurring fluids in a subterranean formation) and/or injected fluids (e.g., fluid that has been injected into the well). In some embodiments, tools may be inserted into the bulk fluid using one or more cables (e.g., a wireline, a slickline). Non-limiting examples of tools that may be inserted into the well using one or more cables include transducers, scintillators, sensors, emitters, receivers, logging tools, resistivity tools, seismic tools, and/or perforating tools. In some embodiments, power may be transmitted to the tools from the surface (e.g., from a power supply located at the surface). In some cases, data may be transmitted to and/or from the tools to the surface through the one or more cables. In some embodiments, one or more conduits (e.g., a pipe, coiled tubing) may be inserted into the bulk fluid of an oil and/or gas well. For example, fluids may be injected into the well through the one or more conduits. In some embodiments, the one or more conduits may be in fluid communication with a fluid source (e.g., a fluid source located at the surface).

In some embodiments, acoustic and/or ultrasonic energy may be coupled to a fluid stream by an acoustic and/or ultrasonic transducer. An acoustic transducer generally refers to a device that converts energy (e.g., electrical energy) into waves having a frequency in the range of about 20 Hz to about 20 kHz. An ultrasonic transducer generally refers to a device that converts energy (e.g., electrical energy) into waves having a frequency of at least about 20 kHz. Non-limiting examples of suitable acoustic and/or ultrasonic transducers include piezoelectric transducers and magnetostrictive transducers. In some embodiments, the acoustic and/or ultrasonic transducer may emit waves having a frequency of at least about 20 Hz, at least about 50 Hz, at least about 100 Hz, at least about 150 Hz, at least about 200 Hz, at least about 250 Hz, at least about 500 Hz, at least about 1 kHz, at least about 5 kHz, at least about 10 kHz, at least about 15 kHz, at least about 20 kHz, at least about 25 kHz, at least about 30 kHz, at least about 35 kHz, at least about 40 kHz, at least about 45 kHz, at least about 50 kHz, at least about 60 kHz, at least about 70 kHz, at least about 80 kHz, at least about 90 kHz, at least about 100 kHz, at least about 150 kHz, at least about 200 kHz, at least about 250 kHz, at least about 300 kHz, at least about 350 kHz, or at least about 400 kHz. In some embodiments, the acoustic and/or ultrasonic transducer may emit waves having a frequency of less than about 400 kHz, less than about 350 kHz, less than about 300 kHz, less than about 250 kHz, less than about 200 kHz, less than about 150 kHz, less than about 100 kHz, less than about 90 kHz, less than about 80 kHz, less than about 70 kHz, less than about 60 kHz, less than about 50 kHz, less than about 45 kHz, less than about 40 kHz, less than about 35 kHz, less than about 30 kHz, less than about 25 kHz, less than about 20 kHz, less than about 15 kHz, less than about 10 kHz, less than about 5 kHz, less than about 1 kHz, less than about 500 Hz, less than about 250 Hz, less than about 200 Hz, less than about 150 Hz, less than about 100 Hz, less than about 50 Hz, or less than about 20 Hz. In some embodiments, the acoustic and/or ultrasonic transducer may emit waves having a frequency between about 20 Hz and about 200 Hz, between about 20 Hz and about 500 Hz, between about 20 Hz and about 1 kHz, between about 20 Hz and about 10 kHz, between about 20 Hz and about 20 kHz, between about 20 Hz and about 30 kHz, between about 20 Hz and about 40 kHz, between about 20 Hz and about 50 kHz, between about 20 Hz and about 100 kHz, between about 20 Hz and about 200 kHz, between about 20 Hz and about 300 kHz, between about 20 Hz and about 400 kHz, between about 50 Hz and about 200 Hz, between about 50 Hz and about 1 kHz, between about 50 Hz and about 20 kHz, between about 50 Hz and about 50 kHz, between about 50 Hz and about 100 kHz, between about 50 Hz and about 400 kHz, between about 100 Hz and about 200 Hz, between about 100 Hz and about 1 kHz, between about 100 Hz and about 20 kHz, between about 100 Hz and about 100 kHz, between about 100 Hz and about 100 kHz, between about 100 Hz and about 400 kHz, between about 1 kHz and about 20 kHz, between about 1 kHz and about 50 kHz, between about 1 kHz and about 100 kHz, between about 1 kHz and about 400 kHz, between about 20 kHz and about 100 kHz, between about 20 kHz and about 400 kHz, or between about 50 kHz and about 400 kHz.

In some embodiments, the acoustic and/or ultrasonic transducer may emit acoustic and/or ultrasonic waves that are transmitted to a fluid stream comprising an emulsion or a microemulsion, thereby coupling acoustic and/or ultrasonic energy to the fluid stream. The acoustic and/or ultrasonic transducer may be positioned in any location that allows acoustic and/or ultrasonic waves emitted by the transducer to be transmitted to the fluid stream. In certain cases, the transducer may be located at or near the exit of a conduit through which the fluid stream is being injected into the oil and/or gas well. For example, in some embodiments, the fluid stream may be ejected from a nozzle into the well. In some such embodiments, the transducer may be coupled to the nozzle. In some embodiments, the transducer may transmit acoustic and/or ultrasonic waves to the fluid stream prior to the stream exiting through the fluid outlet of a conduit (e.g., a nozzle) into the well. For example, in some cases, the transducer may be located upstream of a fluid outlet of the conduit. The transducer may be located inside the conduit (e.g., within the stream of fluid flowing through the conduit) or outside the conduit (e.g., associated with an exterior wall of the conduit). In some embodiments, the transducer may be connected to a wireline, and fluid may be injected into the well through coiled tubing. In some embodiments, the transducer may transmit acoustic and/or ultrasonic waves to the fluid stream after the stream has exited through a fluid outlet of the conduit into the well. For example, in certain cases, the transducer may be located in the bulk fluid. In some such cases, acoustic and/or ultrasonic waves may propagate through the bulk fluid and be transmitted to the fluid stream. In some cases, the transducer may be associated with an interior wall of the wellbore. In some embodiments, there may be two or more acoustic and/or ultrasonic transducers in or associated with an oil and/or gas well.

In some cases, where acoustic and/or ultrasonic waves are transmitted to the fluid stream comprising an emulsion or microemulsion through one or more transmission media (e.g., bulk fluid, conduit material), the transmitted waves may be attenuated or intensified. In some cases, the acoustic and/or ultrasonic waves transmitted to the fluid stream may have a frequency of at least about 20 Hz, at least about 50 Hz, at least about 100 Hz, at least about 150 Hz, at least about 200 Hz, at least about 250 Hz, at least about 500 Hz, at least about 1 kHz, at least about 5 kHz, at least about 10 kHz, at least about 15 kHz, at least about 20 kHz, at least about 25 kHz, at least about 30 kHz, at least about 35 kHz, at least about 40 kHz, at least about 45 kHz, at least about 50 kHz, at least about 60 kHz, at least about 70 kHz, at least about 80 kHz, at least about 90 kHz, at least about 100 kHz, at least about 150 kHz, at least about 200 kHz, at least about 250 kHz, at least about 300 kHz, at least about 350 kHz, or at least about 400 kHz. In some embodiments, the acoustic and/or ultrasonic waves transmitted to the fluid stream may have a frequency of less than about 400 kHz, less than about 350 kHz, less than about 300 kHz, less than about 250 kHz, less than about 200 kHz, less than about 150 kHz, less than about 100 kHz, less than about 90 kHz, less than about 80 kHz, less than about 70 kHz, less than about 60 kHz, less than about 50 kHz, less than about 45 kHz, less than about 40 kHz, less than about 35 kHz, less than about 30 kHz, less than about 25 kHz, less than about 20 kHz, less than about 15 kHz, less than about 10 kHz, less than about 5 kHz, less than about 1 kHz, less than about 500 Hz, less than about 250 Hz, less than about 200 Hz, less than about 150 Hz, less than about 100 Hz, less than about 50 Hz, or less than about 20 Hz. In some embodiments, the acoustic and/or ultrasonic waves transmitted to the fluid stream may have a frequency between about 20 Hz and about 200 Hz, between about 20 Hz and about 500 Hz, between about 20 Hz and about 1 kHz, between about 20 Hz and about 10 kHz, between about 20 Hz and about 20 kHz, between about 20 Hz and about 30 kHz, between about 20 Hz and about 40 kHz, between about 20 Hz and about 50 kHz, between about 20 Hz and about 100 kHz, between about 20 Hz and about 200 kHz, between about 20 Hz and about 300 kHz, between about 20 Hz and about 400 kHz, between about 50 Hz and about 200 Hz, between about 50 Hz and about 1 kHz, between about 50 Hz and about 20 kHz, between about 50 Hz and about 50 kHz, between about 50 Hz and about 100 kHz, between about 50 Hz and about 400 kHz, between about 100 Hz and about 200 Hz, between about 100 Hz and about 1 kHz, between about 100 Hz and about 20 kHz, between about 100 Hz and about 100 kHz, between about 100 Hz and about 100 kHz, between about 100 Hz and about 400 kHz, between about 1 kHz and about 20 kHz, between about 1 kHz and about 50 kHz, between about 1 kHz and about 100 kHz, between about 1 kHz and about 400 kHz, between about 20 kHz and about 100 kHz, between about 20 kHz and about 400 kHz, or between about 50 kHz and about 400 kHz.

Acoustic and/or ultrasonic energy may be transmitted from the fluid stream comprising an emulsion or a microemulsion to other parts of the oil and/or gas well. For example, in some embodiments, acoustic and/or ultrasonic energy may be transmitted from the fluid stream to the bulk fluid. In some embodiments, acoustic and/or ultrasonic energy may be transmitted from the fluid stream to an interface between the fluid stream and the wellbore. In some embodiments, acoustic and/or ultrasonic energy may be transmitted from the fluid stream to the wellbore. In some such embodiments, the acoustic and/or ultrasonic energy may increase the effectiveness of the fluid in, for example, disintegrating and/or dislodging deposits of impurities lining the wellbore or otherwise enhancing the productivity of the oil and/or gas well.

In some embodiments, the fluid stream is an oscillating fluid stream. As used herein, an “oscillating fluid stream” refers to a fluid stream through which a wave (e.g., an acoustic wave, an ultrasonic wave, a pulse wave) propagates. The oscillating fluid stream may have an associated frequency (e.g., the frequency of the wave propagating through the fluid). In some embodiments, the oscillating fluid stream may have a frequency of at least about 20 Hz, at least about 50 Hz, at least about 100 Hz, at least about 150 Hz, at least about 200 Hz, at least about 250 Hz, at least about 500 Hz, at least about 1 kHz, at least about 5 kHz, at least about 10 kHz, at least about 15 kHz, at least about 20 kHz, at least about 25 kHz, at least about 30 kHz, at least about 35 kHz, at least about 40 kHz, at least about 45 kHz, at least about 50 kHz, at least about 60 kHz, at least about 70 kHz, at least about 80 kHz, at least about 90 kHz, at least about 100 kHz, at least about 150 kHz, at least about 200 kHz, at least about 250 kHz, at least about 300 kHz, at least about 350 kHz, or at least about 400 kHz. In some embodiments, the oscillating fluid stream may have a frequency of less than about 400 kHz, less than about 350 kHz, less than about 300 kHz, less than about 250 kHz, less than about 200 kHz, less than about 150 kHz, less than about 100 kHz, less than about 90 kHz, less than about 80 kHz, less than about 70 kHz, less than about 60 kHz, less than about 50 kHz, less than about 45 kHz, less than about 40 kHz, less than about 35 kHz, less than about 30 kHz, less than about 25 kHz, less than about 20 kHz, less than about 15 kHz, less than about 10 kHz, less than about 5 kHz, less than about 1 kHz, less than about 500 Hz, less than about 250 Hz, less than about 200 Hz, less than about 150 Hz, less than about 100 Hz, less than about 50 Hz, or less than about 20 Hz. In some embodiments, the oscillating fluid stream may have a frequency between about 20 Hz and about 200 Hz, between about 20 Hz and about 500 Hz, between about 20 Hz and about 1 kHz, between about 20 Hz and about 10 kHz, between about 20 Hz and about 20 kHz, between about 20 Hz and about 30 kHz, between about 20 Hz and about 40 kHz, between about 20 Hz and about 50 kHz, between about 20 Hz and about 100 kHz, between about 20 Hz and about 200 kHz, between about 20 Hz and about 300 kHz, between about 20 Hz and about 400 kHz, between about 50 Hz and about 200 Hz, between about 50 Hz and about 1 kHz, between about 50 Hz and about 20 kHz, between about 50 Hz and about 50 kHz, between about 50 Hz and about 100 kHz, between about 50 Hz and about 400 kHz, between about 100 Hz and about 200 Hz, between about 100 Hz and about 1 kHz, between about 100 Hz and about 20 kHz, between about 100 Hz and about 100 kHz, between about 100 Hz and about 100 kHz, between about 100 Hz and about 400 kHz, between about 1 kHz and about 20 kHz, between about 1 kHz and about 50 kHz, between about 1 kHz and about 100 kHz, between about 1 kHz and about 400 kHz, between about 20 kHz and about 100 kHz, between about 20 kHz and about 400 kHz, or between about 50 kHz and about 400 kHz.

Some embodiments relate to generating an oscillating fluid stream. In some embodiments, a fluid may be flowed through a nozzle in fluid communication with a well (e.g., wellbore). The nozzle may, in some cases, comprise a fluid inlet and one or more fluid outlets. In certain embodiments, a fluid comprising an emulsion or a microemulsion may be flowed from a fluid source through a conduit (e.g., a pipe and/or tube) to the fluid inlet of the nozzle. One or more fluid streams may then be ejected from the one or more fluid outlets into the well, thereby forming the oscillating fluid stream.

In some embodiments, the nozzle may be positioned inside the well (e.g., wellbore). For example, the nozzle may be suspended within the well. In some embodiments, the nozzle may be positioned outside the well (e.g., at or near the entrance to the well). The nozzle may have a cross section (e.g., in a plane perpendicular to the principal direction of fluid flow) of any shape. For example, the nozzle may have a cross-sectional shape that is rectangular, square, elliptical, circular, triangular, hexagonal, and/or any other shape. In some embodiments, the area of the cross section may vary along the length of the nozzle.

In some embodiments, the oscillating fluid stream may be a pulsating fluid stream and/or a vibrating fluid stream. As used herein, a “pulsating fluid stream” refers to a stream comprising periodic, discontinuous pulses of fluid. For example, a pulsating fluid stream may be generated when periodic bursts of fluid are ejected from one or more fluid outlets of a nozzle. The frequency of a pulsating stream may be obtained by counting the number of pulses of fluid ejected per second. As used herein, a “vibrating fluid stream” refers to a stream comprising a continuous stream of fluid, where a wave (e.g., an acoustic wave) is propagated through the fluid stream. For example, a vibrating fluid stream may be generated through the oscillatory motion of a nozzle. The frequency of a vibrating stream may correspond to the frequency of the wave propagating through the fluid stream.

In some embodiments, a pulsating fluid stream may be ejected from a fluid outlet of a nozzle. The nozzle may be stationary or in motion when the fluid stream is being ejected. For example, a pulsating fluid stream may be generated by positioning a rotary blocking element (e.g., an element that rotates about a rotational axis) between a fluid source and a nozzle fluid outlet. The rotary blocking element may periodically open and close the fluid passage from the fluid source to the fluid outlet, with a pulse of fluid being ejected when the fluid passage is open. In some embodiments, a valve may be located between the fluid source and the nozzle fluid outlet. In certain cases, the valve may be in communication with an actuator. The actuator may be adapted to periodically open the valve to allow pulses of fluid to be periodically ejected from the fluid outlet of the nozzle.

In some embodiments, a pulsating fluid stream may be ejected from two or more fluid outlets of a nozzle. The nozzle may be stationary or in motion when the fluid stream is being ejected. In some embodiments, a pulsating fluid stream may be simultaneously ejected from each fluid outlet. In certain cases, the frequency of each pulsating fluid stream may be the same. In some cases, the frequency of one pulsating fluid stream ejected from a fluid outlet may be different from at least one other pulsating fluid stream ejected from a different fluid outlet. In some embodiments, a pulsating fluid stream may be alternately ejected from two or more fluid outlets. For example, a nozzle may comprise a fluid inlet, a chamber in fluid communication with the fluid inlet, at least two fluid outlets, and at least two fluid passages, where each passage is in fluid communication with the chamber and one fluid outlet. In some embodiments, a fluid stream may flow continuously into the fluid inlet of the nozzle, but may alternately flow through each of the at least two fluid outlets.

In certain cases, alternating negative pressure conditions may cause the fluid stream to switch between the at least two fluid passages leading to the at least two fluid outlets. For example, the nozzle may further comprise a vacuum port. High-velocity flow of a fluid through a fluid passage, past an end of the vacuum port, may create a negative pressure condition in a different fluid passage. In some embodiments, generation of turbulent flow within the nozzle may cause the fluid stream to switch between the at least two fluid passages leading to the at least two fluid outlets. Turbulent flow may be generated, for example, via surface discontinuities and/or protrusions.

In some embodiments, a vibrating fluid stream may be generated by oscillatory motion of a nozzle as fluid is flowed through the nozzle. For example, in certain cases, the nozzle may move up and down (e.g., parallel to the principal direction of fluid flow). In some embodiments, the nozzle may move side to side (e.g., in a plane perpendicular to the principal direction of fluid flow). The oscillatory motion of the nozzle may, in certain cases, cause a wave (e.g., an acoustic wave) to propagate through the fluid stream ejected from at least one fluid outlet of the nozzle. In some embodiments, a fluid stream may be continuously ejected from at least one fluid outlet of the nozzle while the nozzle is oscillating. In some embodiments, periodic pulses of fluid may be ejected from at least one fluid outlet of the nozzle while the nozzle is oscillating.

In some embodiments, the oscillating fluid stream may exert a pressure on material in the vicinity of the nozzle. For example, the material may comprise deposits of impurities in the well. In some embodiments, the pressure exerted may be at least about 1 MPa, at least about 2 MPa, at least about 5 MPa, at least about 10 MPa, at least about 15 MPa, at least about 20 MPa, at least about 50 MPa, at least about 60 MPa, at least about 70 MPa, at least about 80 MPa, at least about 90 MPa, or at least about 100 MPa. In some embodiments, the pressure exerted may be less than about 100 MPa, less than about 90 MPa, less than about 80 MPa, less than about 70 MPa, less than about 60 MPa, less than about 50 MPa, less than about 20 MPa, less than about 15 MPa, less than about 10 MPa, less than about 5 MPa, less than about 2 MPa, or less than about 1 MPa. In some embodiments, the pressure exerted is in the range of about 1 MPa to about 10 MPa, about 1 MPa to about 50 MPa, about 1 MPa to about 100 MPa, about 10 MPa to about 50 MPa, about 10 MPa to about 100 MPa, or about 50 MPa to about 100 MPa.

In some embodiments, fluid may be ejected from at least one fluid outlet of the nozzle at a flow rate of at least about 10 L/min, at least about 20 L/min, at least about 50 L/min, at least about 100 L/min, at least about 150 L/min, at least about 200 L/min, at least about 500 L/min, at least about 700 L/min, or at least about 1000 L/min. In some embodiments, fluid may be ejected at a flow rate of less than about 1000 L/min, less than about 700 L/min, less than about 500 L/min, less than about 200 L/min, less than about 150 L/min, less than about 100 L/min, less than about 50 L/min, less than about 20 L/min, or less than about 10 L/min. In some embodiments, fluid may be ejected at a flow rate between about 10 L/min and 100 L/min, between about 10 L/min and about 500 L/min, between about 10 L/min and about 1000 L/min, between about 100 L/min and about 500 L/min, between about 100 L/min and about 1000 L/min, or between about 500 L/min and about 1000 L/min.

In some embodiments, the oscillating fluid stream may be injected into an oil and/or gas well at a temperature of at least about 20° C., at least about 50° C., at least about 100° C., or at least about 150° C. In some embodiments, the oscillating fluid stream may be injected into an oil and/or gas well at a temperature of less than about 150° C., less than about 100° C., less than about 50° C., or less than about 20° C. In some embodiments, the oscillating fluid stream may be injected into an oil and/or gas well at a temperature in the range of about 20° C. to about 100° C. or about 20° C. to about 150° C.

In some embodiments, the oil and/or gas well may be a vertical well. In some embodiments, the oil and/or gas well may be a horizontal well. In some embodiments, the well may have a depth of at least about 20 feet, at least about 50 feet, at least about 100 feet, at least about 150 feet, at least about 200 feet, at least about 500 feet, at least about 1,000 feet, at least about 2,000 feet, at least about 5,000 feet, at least about 10,000 feet, at least about 15,000 feet, at least about 20,000 feet, or at least about 25,000 feet.

Aspects of the invention may be applied throughout the life cycle of an oil and/or gas well. For example, in some cases, an oscillating fluid stream comprising an emulsion or a microemulsion may be injected into a well prior to hydraulic fracturing. For example, the method may be applied to clean the well and/or prepare a formation for hydraulic fracturing. In some embodiments, the oscillating stream may be injected into a well following hydraulic fracturing. For example, the method may be employed to remove deposits from perforations. During production, the oscillating fluid stream comprising an emulsion or a microemulsion may be used to fragmentize and remove deposits of impurities within the well. As the oil and/or gas well matures, the oscillating fluid stream comprising an emulsion or a microemulsion may be injected into the well to address post-production decline.

In some embodiments, the compositions and methods described herein comprise an emulsion or a microemulsion. The terms should be understood to include emulsions or microemulsions that have a water continuous phase, or that have an oil continuous phase, or microemulsions that are bicontinuous, or multiple continuous phases of water and oil.

It should be understood, that in embodiments where an emulsion or a microemulsion is employed, the emulsion or microemulsion may be diluted and/or combined with other liquid component(s) prior to and/or during injection. For example, in some embodiments, the microemulsion is diluted with an aqueous carrier fluid (e.g., water, brine, sea water, fresh water, or a well-treatment fluid (e.g., an acid, a fracturing fluid comprising polymers, sand, slickwater, etc.) prior to and/or during injection into the well. In some embodiments, a composition for injecting into a well is provided comprising a microemulsion as described herein and an aqueous carrier fluid, wherein the microemulsion is present in an amount between about 0.1 and about 50 gallons per thousand gallons of dilution fluid (“gpt”), or between about 0.5 and about 10 gpt, or between about 0.5 and about 2 gpt. In certain embodiments, the microemulsion is present in an amount between about 2 and about 10 gpt. In some embodiments, microemulsion is present in an amount between about 2 and about 20 gpt, or between about 1 and about 50 gpt.

As used herein, the term “emulsion” is given its ordinary meaning in the art and refers to dispersions of one immiscible liquid in another, in the form of droplets, with diameters approximately in the range of 100-1,000 nanometers. Emulsions may be thermodynamically unstable and/or require high shear forces to induce their formation.

As used herein, the term “microemulsion” is given its ordinary meaning in the art and refers to dispersions of one immiscible liquid in another, in the form of droplets, with diameters approximately in the range of between about 1 and about 1000 nm, or between 10 and about 1000 nanometers, or between about 10 and about 500 nm, or between about 10 and about 300 nm, or between about 10 and about 100 nm. Microemulsions are clear or transparent because they contain particles smaller than the wavelength of visible light. In addition, microemulsions are homogeneous thermodynamically stable single phases, and form spontaneously, and thus, differ markedly from thermodynamically unstable emulsions, which generally depend upon intense mixing energy for their formation. Microemulsions may be characterized by a variety of advantageous properties including, by not limited to, (i) clarity, (ii) very small particle size, (iii) ultra-low interfacial tensions, (iv) the ability to combine properties of water and oil in a single homogeneous fluid, (v) shelf life stability, and (vi) ease of preparation.

In some embodiments, the microemulsions may be stabilized microemulsions that are formed by the combination of a solvent-surfactant blend with an appropriate oil-based or water-based carrier fluid. Generally, the microemulsion forms upon simple mixing of the components without the need for high shearing generally required in the formation of ordinary emulsions. In some embodiments, the microemulsion is a thermodynamically stable system, and the droplets remain finely dispersed over time. In some cases, the average droplet size ranges from about 10 nm to about 300 nm.

It should be understood that while much of the description herein focuses on microemulsions, this is by no means limiting, and emulsions may be employed where appropriate.

In some embodiments, a microemulsion comprises water, a solvent, and a surfactant. In some embodiments, the microemulsion may further comprise additional components, for example, a freezing point depression agent. Details of each of the components of the microemulsions are described herein. In some embodiments, the components of the microemulsions are selected so as to reduce or eliminate the hazards of the microemulsion to the environment and/or the subterranean reservoirs.

In some embodiments, the emulsion or microemulsion is a single emulsion or microemulsion. For example, the emulsion or microemulsion comprises a single layer of a surfactant. In other embodiments, the emulsion or microemulsion may be a double or multilamellar emulsion or microemulsion. For example, the emulsion or microemulsion comprises two or more layers of a surfactant. In some embodiments, the emulsion or microemulsion comprises a single layer of surfactant surrounding a core (e.g., one or more of water, oil, solvent, and/or other additives) or a multiple layers of surfactant (e.g., two or more concentric layers surrounding the core). In certain embodiments, the emulsion or microemulsion comprises two or more immiscible cores (e.g., one or more of water, oil, solvent, and/or other additives which have equal or about equal affinities for the surfactant).

The microemulsion generally comprises a solvent. The solvent, or a combination of solvents, may be present in the microemulsion in any suitable amount. In some embodiments, the total amount of solvent present in the microemulsion is between about 2 wt % and about 60 wt %, or between about 5 wt % and about 40 wt %, or between about 5 wt % and about 30 wt %, versus the total microemulsion composition.

Those of ordinary skill in the art will appreciate that emulsions or microemulsions comprising more than two types of solvents may be utilized in the methods, compositions, and systems described herein. For example, the microemulsion may comprise more than one or two types of solvent, for example, three, four, five, six, or more, types of solvents. In some embodiments, the emulsion or microemulsion comprises a first type of solvent and a second type of solvent. The first type of solvent to the second type of solvent ratio in a microemulsion may be present in any suitable ratio. In some embodiments, the ratio of the first type of solvent to the second type of solvent is between about 4:1 and 1:4, or between 2:1 and 1:2, or about 1:1.

The aqueous phase (e.g., water) to solvent ratio in a microemulsion may be varied. In some embodiments, the ratio of the aqueous phase (e.g., water) to solvent by weight, along with other parameters of the solvent may be varied. In some embodiments, the ratio of water to solvent by weight is between about 15:1 and 1:10, or between 9:1 and 1:4, or between 3.2:1 and 1:4.

In some embodiments, the solvent is an unsubstituted cyclic or acyclic, branched or unbranched alkane having 6-12 carbon atoms. In some embodiments, the cyclic or acyclic, branched or unbranched alkane has 6-10 carbon atoms. Non-limiting examples of unsubstituted acyclic unbranched alkanes having 6-12 carbon atoms include hexane, heptane, octane, nonane, decane, undecane, and dodecane. Non-limiting examples of unsubstituted acyclic branched alkanes having 6-12 carbon atoms include isomers of methylpentane (e.g., 2-methylpentane, 3-methylpentane), isomers of dimethylbutane (e.g., 2,2-dimethylbutane, 2,3-dimethylbutane), isomers of methylhexane (e.g., 2-methylhexane, 3-methylhexane), isomers of ethylpentane (e.g., 3-ethylpentane), isomers of dimethylpentane (e.g., 2,2,-dimethylpentane, 2,3-dimethylpentane, 2,4-dimethylpentane, 3,3-dimethylpentane), isomers of trimethylbutane (e.g., 2,2,3-trimethylbutane), isomers of methylheptane (e.g., 2-methylheptane, 3-methylheptane, 4-methylheptane), isomers of dimethylhexane (e.g., 2,2-dimethylhexane, 2,3-dimethylhexane, 2,4-dimethylhexane, 2,5-dimethylhexane, 3,3-dimethylhexane, 3,4-dimethylhexane), isomers of ethylhexane (e.g., 3-ethylhexane), isomers of trimethylpentane (e.g., 2,2,3-trimethylpentane, 2,2,4-trimethylpentane, 2,3,3-trimethylpentane, 2,3,4-trimethylpentane), and isomers of ethylmethylpentane (e.g., 3-ethyl-2-methylpentane, 3-ethyl-3-methylpentane). Non-limiting examples of unsubstituted cyclic branched or unbranched alkanes having 6-12 carbon atoms include cyclohexane, methylcyclopentane, ethylcyclobutane, propylcyclopropane, isopropylcyclopropane, dimethylcyclobutane, cycloheptane, methylcyclohexane, dimethylcyclopentane, ethylcyclopentane, trimethylcyclobutane, cyclooctane, methylcycloheptane, dimethylcyclohexane, ethylcyclohexane, cyclononane, methylcyclooctane, dimethylcycloheptane, ethylcycloheptane, trimethylcyclohexane, ethylmethylcyclohexane, propylcyclohexane, and cyclodecane. In a particular embodiment, the unsubstituted cyclic or acyclic, branched or unbranched alkane having 6-12 carbon is selected from the group consisting of heptane, octane, nonane, decane, 2,2,4-trimethylpentane (isooctane), and propylcyclohexane.

In some embodiments, the solvent is an unsubstituted acyclic branched or unbranched alkene having one or two double bonds and 6-12 carbon atoms. In some embodiments, the solvent is an unsubstituted acyclic branched or unbranched alkene having one or two double bonds and 6-10 carbon atoms. Non-limiting examples of unsubstituted acyclic unbranched alkenes having one or two double bonds and 6-12 carbon atoms include isomers of hexene (e.g., 1-hexene, 2-hexene), isomers of hexadiene (e.g., 1,3-hexadiene, 1,4-hexadiene), isomers of heptene (e.g., 1-heptene, 2-heptene, 3-heptene), isomers of heptadiene (e.g., 1,5-heptadiene, 1-6, heptadiene), isomers of octene (e.g., 1-octene, 2-octene, 3-octene), isomers of octadiene (e.g., 1,7-octadiene), isomers of nonene, isomers of nonadiene, isomers of decene, isomers of decadiene, isomers of undecene, isomers of undecadiene, isomers of dodecene, and isomers of dodecadiene. In some embodiments, the acyclic unbranched alkene having one or two double bonds and 6-12 carbon atoms is an alpha-olefin (e.g., 1-hexene, 1-heptene, 1-octene, 1-nonene, 1-decene, 1-undecene, 1-dodecene). Non-limiting examples of unsubstituted acyclic branched alkenes include isomers of methylpentene, isomers of dimethylpentene, isomers of ethylpentene, isomers of methylethylpentene, isomers of propylpentene, isomers of methylhexene, isomers of ethylhexene, isomers of dimethylhexene, isomers of methylethylhexene, isomers of methylheptene, isomers of ethylheptene, isomers of dimethylhexptene, and isomers of methylethylheptene. In a particular embodiment, the unsubstituted acyclic unbranched alkene having one or two double bonds and 6-12 carbon atoms is selected from the group consisting of 1-octene and 1,7-octadiene.

In some embodiments, the solvent is a cyclic or acyclic, branched or unbranched alkane having 9-12 carbon atoms and substituted with only an —OH group. Non-limiting examples of cyclic or acyclic, branched or unbranched alkanes having 9-12 carbon atoms and substituted with only an —OH group include isomers of nonanol, isomers of decanol, isomers of undecanol, and isomers of dodecanol. In a particular embodiment, the cyclic or acyclic, branched or unbranched alkane having 9-12 carbon atoms and substituted with only an —OH group is selected from the group consisting of 1-nonanol and 1-decanol.

In some embodiments, the solvent is a branched or unbranched dialkylether compound having the formula CₙH₂ₙ₊₁OCₘH₂ₘ₊₁ wherein n+m is between 6 and 16. In some cases, n+m is between 6 and 12, or between 6 and 10, or between 6 and 8. Non-limiting examples of branched or unbranched dialkylether compounds having the formula CₙH₂ₙ₊₁OCₘH₂ₘ₊₁ include isomers of C₃H₇OC₃H₇, isomers of C₄H₉OC₄H₉, isomers of C₄H₉OC₃H₇, isomers of C₅H₁₁OC₃H₇, isomers of C₆H₁₃OC₃H₇, isomers of C₄H₉OC₄H₉, isomers of C₄H₉OC₅H₁₁, isomers of C₄H₉OC₆H₁₃, isomers of C₅H₁₁OC₆H₁₃, and isomers of C₆H₁₃OC₆H₁₃. In a particular embodiment, the branched or unbranched dialklyether is an isomer C₆H₁₃OC₆H₁₃ (e.g., dihexylether).

In some embodiments, the solvent is an aromatic solvent having a boiling point between about 300-400° F. Non-limiting examples of aromatic solvents having a boiling point between about 300-400° F. include butylbenzene, hexylbenzene, mesitylene, light aromatic naphtha, and heavy aromatic naphtha.

In some embodiments, the solvent is a cyclic or acyclic, branched or unbranched alkane having 8 carbon atoms and substituted with only an —OH group. Non-limiting examples of cyclic or acyclic, branched or unbranched alkanes having 8 carbon atoms and substituted with only an —OH group include isomers of octanol (e.g., 1-octanol, 2-octanol, 3-octanol, 4-octanol), isomers of methyl heptanol, isomers of ethylhexanol (e.g., 2-ethyl-1-hexanol, 3-ethyl-1-hexanol, 4-ethyl-1-hexanol), isomers of dimethylhexanol, isomers of propylpentanol, isomers of methylethylpentanol, and isomers of trimethylpentanol. In a particular embodiment, the cyclic or acyclic, branched or unbranched alkane having 8 carbon atoms and substituted with only an —OH group is selected from the group consisting of 1-octanol and 2-ethyl-1-hexanol.

In some embodiments, the solvent is an aromatic solvent having a boiling point between about 175-300° F. Non-limiting examples of aromatic liquid solvents having a boiling point between about 175-300° F. include benzene, xylenes, and toluene. In a particular embodiment, the solvent is not xylene.

In some embodiments, at least one of the solvents present in the microemulsion is a terpene or a terpenoid. In some embodiments, the terpene or terpenoid comprises a first type of terpene or terpenoid and a second type of terpene or terpenoid. Terpenes may be generally classified as monoterpenes (e.g., having two isoprene units), sesquiterpenes (e.g., having 3 isoprene units), diterpenes, or the like. The term terpenoid also includes natural degradation products, such as ionones, and natural and synthetic derivatives, e.g., terpene alcohols, aldehydes, ketones, acids, esters, epoxides, and hydrogenation products (e.g., see Ullmann's Encyclopedia of Industrial Chemistry, 2012, pages 29-45, herein incorporated by reference). It should be understood that while much of the description herein focuses on terpenes, this is by no means limiting, and terpenoids may be employed where appropriate. In some cases, the terpene is a naturally occurring terpene. In some cases, the terpene is a non-naturally occurring terpene and/or a chemically modified terpene (e.g., saturated terpene, terpene amine, fluorinated terpene, or silylated terpene).

In some embodiments, the terpene is a monoterpene. Monoterpenes may be further classified as acyclic, monocyclic, and bicyclic (e.g., with a total number of carbons in the range between 18 and 20), as well as whether the monoterpene comprises one or more oxygen atoms (e.g., alcohol groups, ester groups, carbonyl groups, etc.). In some embodiments, the terpene is an oxygenated terpene, for example, a terpene comprising an alcohol, an aldehyde, and/or a ketone group. In some embodiments, the terpene comprises an alcohol group. Non-limiting examples of terpenes comprising an alcohol group are linalool, geraniol, nopol, α-terpineol, and menthol. In some embodiments, the terpene comprises an ether-oxygen, for example, eucalyptol, or a carbonyl oxygen, for example, menthone. In some embodiments, the terpene does not comprise an oxygen atom, for example, d-limonene.

Non-limiting examples of terpenes include linalool, geraniol, nopol, α-terpineol, menthol, eucalyptol, menthone, d-limonene, terpinolene, β-occimene, γ-terpinene, α-pinene, and citronellene. In a particular embodiment, the terpene is selected from the group consisting of α-terpeneol, α-pinene, nopol, and eucalyptol. In one embodiment, the terpene is nopol. In another embodiment, the terpene is eucalyptol. In some embodiments, the terpene is not limonene (e.g., d-limonene). In some embodiments, the emulsion is free of limonene.

In some embodiments, the terpene is a non-naturally occurring terpene and/or a chemically modified terpene (e.g., saturated terpene). In some cases, the terpene is a partially or fully saturated terpene (e.g., p-menthane, pinane). In some cases, the terpene is a non-naturally occurring terpene. Non-limiting examples of non-naturally occurring terpenes include menthene, p-cymene, r-carvone, terpinenes (e.g., alpha-terpinenes, beta-terpinenes, gamma-terpinenes), dipentenes, terpinolenes, borneol, alpha-terpinamine, and pine oils.

In some embodiments, the terpene may be classified in terms of its phase inversion temperature (“PIT”). The term “phase inversion temperature” is given its ordinary meaning in the art and refers to the temperature at which an oil in water microemulsion inverts to a water in oil microemulsion (or vice versa). Those of ordinary skill in the art will be aware of methods for determining the PIT for a microemulsion comprising a terpene (e.g., see Strey, Colloid & Polymer Science, 1994. 272(8): p. 1005-1019; Kahlweit et al., Angewandte Chemie International Edition in English, 1985. 24(8): p. 654-668). The PIT values described herein were determined using a 1:1 ratio of terpene (e.g., one or more terpenes):de-ionized water and varying amounts (e.g., between about 20 wt % and about 60 wt %; generally, between 3 and 9 different amounts are employed) of a 1:1 blend of surfactant comprising linear C₁₂-C₁₅ alcohol ethoxylates with on average 7 moles of ethylene oxide (e.g., Neodol 25-7):isopropyl alcohol wherein the upper and lower temperature boundaries of the microemulsion region can be determined and a phase diagram may be generated. Those of ordinary skill in the art will recognize that such a phase diagram (e.g., a plot of temperature against surfactant concentration at a constant oil-to-water ratio) may be referred to as “fish” diagram or a Kahlweit plot. The temperature at the vertex is the PIT. PITs for non-limiting examples of terpenes determined using this experimental procedure outlined above are given in Table 1.

TABLE 1
Phase inversion temperatures for non-limiting examples of terpenes.

| Terpene | Phase Inversion Temperature ° F. (° C.) |
|---|---|
| linalool | 24.8 (−4) |
| geraniol | 31.1 (−0.5) |
| nopol | 36.5 (2.5) |
| α-terpineol | 40.3 (4.6) |
| menthol | 60.8 (16) |
| eucalyptol | 87.8 (31) |
| menthone | 89.6 (32) |
| d-limonene | 109.4 (43) |
| terpinolene | 118.4 (48) |
| β-occimene | 120.2 (49) |
| γ-terpinene | 120.2 (49) |
| α-pinene | 134.6 (57) |
| citronellene | 136.4 (58) |

In certain embodiments, the solvent utilized in the emulsion or microemulsion herein may comprise one or more impurities. For example, in some embodiments, a solvent (e.g., a terpene) is extracted from a natural source (e.g., citrus), and may comprise one or more impurities present from the extraction process. In some embodiment, the solvent comprises a crude cut (e.g., uncut crude oil, for example, made by settling, separation, heating, etc.). In some embodiments, the solvent is a crude oil (e.g., naturally occurring crude oil, uncut crude oil, crude oil extracted from the wellbore, synthetic crude oil, etc.). In some embodiments, the solvent is a citrus extract (e.g., crude orange oil, orange oil, etc.).

The terpene may be present in the microemulsion in any suitable amount. In some embodiments, terpene is present in an amount between about In some embodiments, terpene is present in an amount between about 2 wt % and about 60 wt %, or between about 5 wt % and about 40 wt %, or between about 5 wt % and about 30 wt %, versus the total microemulsion composition. In some embodiments, the terpene is present in an amount between about 1 wt % and about 99 wt %, or between about 2 wt % and about 90 wt %, or between about 1 wt % and about 60 wt %, or between about 2 wt % and about 60 wt %, or between about 1 wt % and about 50 wt %, or between about 1 wt % and about 30 wt %, or between about 5 wt % and about 40 wt %, or between about 5 wt % and about 30 wt %, or between about 2 wt % and about 25 wt %, or between about 5 wt % and about 25 wt %, or between about 60 wt % and about 95 wt %, or between about 70 wt % or about 95 wt %, or between about 75 wt % and about 90 wt %, or between about 80 wt % and about 95 wt %, versus the total microemulsion composition.

The water to terpene ratio in a microemulsion may be varied, as described herein. In some embodiments, the ratio of water to terpene, along with other parameters of the terpene (e.g., phase inversion temperature of the terpene) may be varied so that displacement of residual aqueous treatment fluid by formation gas and/or formation crude is preferentially stimulated. In some embodiments, the ratio of water to terpene by weight is between about 3:1 and about 1:2, or between about 2:1 and about 1:1.5. In other embodiments, the ratio of water to terpene is between about 10:1 and about 3:1, or between about 6:1 and about 5:1.

Generally, the microemulsion comprises an aqueous phase comprising water. The water may be provided from any suitable source (e.g., sea water, fresh water, deionized water, reverse osmosis water, water from field production). The water may be present in any suitable amount. In some embodiments, the total amount of water present in the microemulsion is between about 1 wt % about 95 wt %, or between about 1 wt % about 90 wt %, or between about 1 wt % and about 60 wt %, or between about 5 wt % and about 60 wt % or between about 10 and about 55 wt %, or between about 15 and about 45 wt %, versus the total microemulsion composition.

In some embodiments, at the emulsion or microemulsion may comprise mutual solvent which is miscible together with the water and the terpene. In some embodiments, the mutual solvent is present in an amount between about at 0.5 wt % to about 30% of mutual solvent. Non-limiting examples of suitable mutual solvents include ethyleneglycolmonobutyl ether (EGMBE), dipropylene glycol monomethyl ether, short chain alcohols (e.g., isopropanol), tetrahydrofuran, dioxane, dimethylformamide, and dimethylsulfoxide.

Generally, the microemulsion comprises an aqueous phase. Generally, the aqueous phase comprises water. The water may be provided from any suitable source (e.g., sea water, fresh water, deionized water, reverse osmosis water, water from field production). The water may be present in any suitable amount. In some embodiments, the total amount of water present in the microemulsion is between about 1 wt % about 95 wt %, or between about 1 wt % about 90 wt %, or between about 1 wt % and about 60 wt %, or between about 5 wt % and about 60 wt % or between about 10 and about 55 wt %, or between about 15 and about 45 wt %, versus the total microemulsion composition.

In some embodiments, the microemulsion comprises a surfactant. The microemulsion may comprise a single surfactant or a combination of two or more surfactants. For example, in some embodiments, the surfactant comprises a first type of surfactant and a second type of surfactant. The term “surfactant,” as used herein, is given its ordinary meaning in the art and refers to compounds having an amphiphilic structure, which gives them a specific affinity for oil/water-type and water/oil-type interfaces, which helps the compounds to reduce the free energy of these interfaces and to stabilize the dispersed phase of a microemulsion. The term surfactant encompasses cationic surfactants, anionic surfactants, amphoteric surfactants, nonionic surfactants, zwitterionic surfactants, and mixtures thereof. In some embodiments, the surfactant is a nonionic surfactant. Nonionic surfactants generally do not contain any charges. Amphoteric surfactants generally have both positive and negative charges, however, the net charge of the surfactant can be positive, negative, or neutral, depending on the pH of the solution. Anionic surfactants generally possess a net negative charge. Cationic surfactants generally possess a net positive charge. Zwitterionic surfactants are generally not pH dependent. A zwitterion is a neutral molecule with a positive and a negative electrical charge, though multiple positive and negative charges can be present. Zwitterions are distinct from dipole, at different locations within that molecule.

In some embodiments, the surfactant is an amphiphilic block copolymer where one block is hydrophobic and one block is hydrophilic. In some cases, the total molecular weight of the polymer is greater than 5000 daltons. The hydrophilic block of these polymers can be nonionic, anionic, cationic, amphoteric, or zwitterionic.

The term surface energy, as used herein, is given its ordinary meaning in the art and refers to the extent of disruption of intermolecular bonds that occur when the surface is created (e.g., the energy excess associated with the surface as compared to the bulk). Generally, surface energy is also referred to as surface tension (e.g., for liquid-gas interfaces) or interfacial tension (e.g., for liquid-liquid interfaces). As will be understood by those skilled in the art, surfactants generally orient themselves across the interface to minimize the extent of disruption of intermolecular bonds (i.e. lower the surface energy).

Typically, surfactants at an interface between polar and non-polar phases orient themselves at the interface such that the difference in polarity is minimized.

Suitable surfactants for use with the compositions and methods described herein will be known in the art. In some embodiments, the surfactant is an alkyl polyglycol ether, for example, having 2-250 ethylene oxide (EO) (e.g., or 2-200, or 2-150, or 2-100, or 2-50, or 2-40) units and alkyl groups of 4 20 carbon atoms. In some embodiments, the surfactant is an alkylaryl polyglycol ether having 2-250 EO units (e.g., or 2-200, or 2-150, or 2-100, or 2-50, or 2-40) and 8 20 carbon atoms in the alkyl and aryl groups. In some embodiments, the surfactant is an ethylene oxide/propylene oxide (EO/PO) block copolymer having 2-250 EO or PO units (e.g., or 2-200, or 2-150, or 2-100, or 2-50, or 2-40). In some embodiments, the surfactant is a fatty acid polyglycol ester having 6 24 carbon atoms and 2-250 EO units (e.g., or 2-200, or 2-150, or 2-100, or 2-50, or 2-40). In some embodiments, the surfactant is a polyglycol ether of hydroxyl-containing triglycerides (e.g., castor oil). In some embodiments, the surfactant is an alkylpolyglycoside of the general formula R″—O—Zn, where R″ denotes a linear or branched, saturated or unsaturated alkyl group having on average 8-24 carbon atoms and Zn denotes an oligoglycoside group having on average n=1-10 hexose or pentose units or mixtures thereof. In some embodiments, the surfactant is a fatty ester of glycerol, sorbitol, or pentaerythritol. In some embodiments, the surfactant is an amine oxide (e.g., dodecyldimethylamine oxide). In some embodiments, the surfactant is an alkyl sulfate, for example having a chain length of 8-18 carbon atoms, alkyl ether sulfates having 8-18 carbon atoms in the hydrophobic group and 1-40 ethylene oxide (EO) or propylene oxide (PO) units. In some embodiments, the surfactant is a sulfonate, for example, an alkyl sulfonate having 8-18 carbon atoms, an alkylaryl sulfonate having 8-18 carbon atoms, an ester, or half ester of sulfosuccinic acid with monohydric alcohols or alkylphenols having 4-15 carbon atoms, or a multisulfonate (e.g., comprising two, three, four, or more, sulfonate groups). In some cases, the alcohol or alkylphenol can also be ethoxylated with 1-250 EO units (e.g., or 2-200, or 2-150, or 2-100, or 2-50, or 2-40). In some embodiments, the surfactant is an alkali metal salt or ammonium salt of a carboxylic acid or poly(alkylene glycol) ether carboxylic acid having 8-20 carbon atoms in the alkyl, aryl, alkaryl or aralkyl group and 1-250 EO or PO units (e.g., or 2-200, or 2-150, or 2-100, or 2-50, or 2-40). In some embodiments, the surfactant is a partial phosphoric ester or the corresponding alkali metal salt or ammonium salt, e.g., an alkyl and alkaryl phosphate having 8-20 carbon atoms in the organic group, an alkylether phosphate or alkarylether phosphate having 8-20 carbon atoms in the alkyl or alkaryl group and 1-250 EO units (e.g., or 2-200, or 2-150, or 2-100, or 2-50, or 2-40). In some embodiments, the surfactant is a salt of primary, secondary, or tertiary fatty amine having 8 24 carbon atoms with acetic acid, sulfuric acid, hydrochloric acid, and phosphoric acid. In some embodiments, the surfactant is a quaternary alkyl- and alkylbenzylammonium salt, whose alkyl groups have 1-24 carbon atoms (e.g., a halide, sulfate, phosphate, acetate, or hydroxide salt). In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt). In some embodiments, the surfactant is amphoteric or zwitterionic, including sultaines (e.g., cocamidopropyl hydroxysultaine), betaines (e.g., cocamidopropyl betaine), or phosphates (e.g., lecithin). Non limiting examples of specific surfactants include a linear C12 C15 ethoxylated alcohols with 5-12 moles of EO, lauryl alcohol ethoxylate with 4-8 moles of EO, nonyl phenol ethoxylate with 5-9 moles of EO, octyl phenol ethoxylate with 5-9 moles of EO, tridecyl alcohol ethoxylate with 5-9 moles of EO, Pluronic® matrix of EO/PO copolymers, ethoxylated cocoamide with 4-8 moles of EO, ethoxylated coco fatty acid with 7-11 moles of EO, and cocoamidopropyl amine oxide.

In some embodiments, the surfactant is a siloxane surfactant as described in U.S. patent application Ser. No. 13/831,410, filed Mar. 14, 2014, herein incorporated by reference.

In some embodiments, the surfactant is a Gemini surfactant. Gemini surfactants generally have the structure of multiple amphiphilic molecules linked together by one or more covalent spacers. In some embodiments, the surfactant is an extended surfactant, wherein the extended surfactants have the structure where a non-ionic hydrophilic spacer (e.g. ethylene oxide or propylene oxide) connects an ionic hydrophilic group (e.g. carboxylate, sulfate, phosphate).

In some embodiments the surfactant is an alkoxylated polyimine with a relative solubility number (RSN) in the range of 5-20. As will be known to those of ordinary skill in the art, RSN values are generally determined by titrating water into a solution of surfactant in 1,4dioxane. The RSN values are generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic. Non-limiting examples of monomeric repeat units in the hydrophobic chains of block copolymer surfactants are isomers of acrylic, methacrylic, styrenic, isoprene, butadiene, acrylamide, ethylene, propylene, and norbornene. The block copolymer may have a hydrophilic block that is comprised of a polymer chain that is linear, branched, hyper branched, dendritic or cyclic. Non-limiting examples of monomeric repeat units in the hydrophilic chains of the block copolymer surfactants are isomers of acrylic acid, maleic acid, methacrylic acid, ethylene oxide, and acrylamine.

Those of ordinary skill in the art will be aware of methods and techniques for selecting surfactants for use in the microemulsions described herein. In some cases, the surfactant(s) are matched to and/or optimized for the particular oil or solvent in use. In some embodiments, the surfactant(s) are selected by mapping the phase behavior of the microemulsion and choosing the surfactant(s) that gives the desired range of stability. In some cases, the stability of the microemulsion over a wide range of temperatures is targeted as the microemulsion may be subject to a wide range of temperatures due to the environmental conditions present at the subterranean formation. In some cases, the stability of the microemulsion over a wide range of temperatures is targeted as the microemulsion may be subject to a wide range of temperatures due to the environmental conditions present at the subterranean formation and/or reservoir.

The surfactant may be present in the microemulsion in any suitable amount. In some embodiments, the surfactant is present in an amount between about 10 wt % and about 60 wt %, or between about 15 wt % and about 55 wt % versus the total microemulsion composition, or between about 20 wt % and about 50 wt %, versus the total microemulsion composition. In some embodiments, the surfactant is present in an amount between about 0 wt % and about 99 wt %, or between about 10 wt % and about 70 wt %, or between about 0 wt % and about 60 wt %, or between about 1 wt % and about 60 wt %, or between about 5 wt % and about 60 wt %, or between about 10 wt % and about 60 wt %, or between 5 wt % and about 65 wt %, or between 5 wt % and about 55 wt %, or between about 0 wt % and about 40 wt %, or between about 15 wt % and about 55 wt %, or between about 20 wt % and about 50 wt %, versus the total microemulsion composition.

In some embodiments, the emulsion or microemulsion may comprise one or more additives in addition to water, solvent (e.g., one or more types of solvents), and surfactant (e.g., one or more types of surfactants). In some embodiments, the additive is an alcohol, a freezing point depression agent, an acid, a salt, a proppant, a scale inhibitor, a friction reducer, a biocide, a corrosion inhibitor, a buffer, a viscosifier, a clay swelling inhibitor, an oxygen scavenger, and/or a clay stabilizer.

In some embodiments, the microemulsion comprises an alcohol. The alcohol may serve as a coupling agent between the solvent and the surfactant and aid in the stabilization of the microemulsion. The alcohol may also lower the freezing point of the microemulsion. The microemulsion may comprise a single alcohol or a combination of two or more alcohols. In some embodiments, the alcohol is selected from primary, secondary, and tertiary alcohols having between 1 and 20 carbon atoms. In some embodiments, the alcohol comprises a first type of alcohol and a second type of alcohol. Non-limiting examples of alcohols include methanol, ethanol, isopropanol, n-propanol, n-butanol, i-butanol, sec-butanol, iso-butanol, and t-butanol. In some embodiments, the alcohol is ethanol or isopropanol. In some embodiments, the alcohol is isopropanol.

The alcohol may be present in the emulsion in any suitable amount. In some embodiments, the alcohol is present in an amount between about 0 wt % and about 50 wt %, or between about 0.1 wt % and about 50 wt %, or between about 1 wt % and about 50 wt %, or between about 5 wt % and about 40 wt %, or between about 5 wt % and 35 wt %, or between about 1 wt % and about 40 wt % freezing point depression agent, or between about 3 wt % and about 20 wt %, or between about 8 wt % and about 16 wt %, versus the total microemulsion composition.

In some embodiments, the microemulsion comprises a freezing point depression agent. The microemulsion may comprise a single freezing point depression agent or a combination of two or more freezing point depression agents. For example, in some embodiments, the freezing point depression agent comprises a first type of freezing point depression agent and a second type of freezing point depression agent. The term “freezing point depression agent” is given its ordinary meaning in the art and refers to a compound which is added to a solution to reduce the freezing point of the solution. That is, a solution comprising the freezing point depression agent has a lower freezing point as compared to an essentially identical solution not comprising the freezing point depression agent. Those of ordinary skill in the art will be aware of suitable freezing point depression agents for use in the microemulsions described herein. Non-limiting examples of freezing point depression agents include primary, secondary, and tertiary alcohols with between 1 and 20 carbon atoms. In some embodiments, the alcohol comprises at least 2 carbon atoms, alkylene glycols including polyalkylene glycols, and salts. Non-limiting examples of alcohols include methanol, ethanol, i-propanol, n-propanol, t-butanol, n-butanol, n-pentanol, n-hexanol, and 2-ethyl-hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). Non-limiting examples of salts include salts comprising K, Na, Br, Cr, Cr, Cs, or Bi, for example, halides of these metals, including NaCl, KCl, CaCl₂, and MgCl. In some embodiments, the freezing point depression agent comprises an alcohol and an alkylene glycol. Another non-limiting example of a freezing point depression agent is a combination of choline chloride and urea. In some embodiments, the microemulsion comprising the freezing point depression agent is stable over a wide range of temperatures, for example, between about −25° F. to 150° F.

The freezing point depression agent may be present in the microemulsion in any suitable amount. In some embodiments, the freezing point depression agent is present in an amount between about 1 wt % and about 40 wt %, or between about 3 wt % and about 20 wt %, or between about 8 wt % and about 16 wt %, versus the total microemulsion composition.

Further non-limiting examples of other additives include proppants, scale inhibitors, friction reducers, biocides, corrosion inhibitors, buffers, viscosifiers, clay swelling inhibitors, paraffin dispersing additives, asphaltene dispersing additives, and oxygen scavengers.

Non-limiting examples of proppants (e.g., propping agents) include grains of sand, glass beads, crystalline silica (e.g., Quartz), hexamethylenetetramine, ceramic proppants (e.g., calcined clays), resin coated sands, and resin coated ceramic proppants. Other proppants are also possible and will be known to those skilled in the art.

Non-limiting examples of scale inhibitors include one or more of methyl alcohol, organic phosphonic acid salts (e.g., phosphonate salt), polyacrylate, ethane-1,2-diol, calcium chloride, and sodium hydroxide. Other scale inhibitors are also possible and will be known to those skilled in the art.

Non-limiting examples of buffers include acetic acid, acetic anhydride, potassium hydroxide, sodium hydroxide, and sodium acetate. Other buffers are also possible and will be known to those skilled in the art.

Non-limiting examples of corrosion inhibitors include isopropanol, quaternary ammonium compounds, thiourea/formaldehyde copolymers, propargyl alcohol, and methanol. Other corrosion inhibitors are also possible and will be known to those skilled in the art.

Non-limiting examples of biocides include didecyl dimethyl ammonium chloride, gluteral, Dazomet, bronopol, tributyl tetradecyl phosphonium chloride, tetrakis (hydroxymethyl) phosphonium sulfate, AQUCAR™, UCARCIDE™, glutaraldehyde, sodium hypochlorite, and sodium hydroxide. Other biocides are also possible and will be known to those skilled in the art.

Non-limiting examples of clay swelling inhibitors include quaternary ammonium chloride and tetramethylammonium chloride. Other clay swelling inhibitors are also possible and will be known to those skilled in the art.

Non-limiting examples of friction reducers include petroleum distillates, ammonium salts, polyethoxylated alcohol surfactants, and anionic polyacrylamide copolymers. Other friction reducers are also possible and will be known to those skilled in the art.

Non-limiting examples of oxygen scavengers include sulfites, and bisulfites. Other oxygen scavengers are also possible and will be known to those skilled in the art.

Non-limiting examples of paraffin dispersing additives and asphaltene dispersing additives include active acidic copolymers, active alkylated polyester, active alkylated polyester amides, active alkylated polyester imides, aromatic naphthas, and active amine sulfonates. Other paraffin dispersing additives are also possible and will be known to those skilled in the art.

In some embodiments, for the formulations above, the other additives are present in an amount between about 0 wt % about 70 wt %, or between about 0 wt % and about 30 wt %, or between about 1 wt % and about 30 wt %, or between about 1 wt % and about 25 wt %, or between about 1 and about 20 wt %, versus the total microemulsion composition.

In some embodiments, the microemulsion comprises an acid or an acid precursor. For example, the microemulsion may comprise an acid when used during acidizing operations. The microemulsion may comprise a single acid or a combination of two or more acids. For example, in some embodiments, the acid comprises a first type of acid and a second type of acid. Non-limiting examples of acids or di-acids include hydrochloric acid, acetic acid, formic acid, succinic acid, maleic acid, malic acid, lactic acid, and hydrochloric-hydrofluoric acids. In some embodiments, the microemulsion comprises an organic acid or organic di-acid in the ester (or di-ester) form, whereby the ester (or diester) is hydrolyzed in the wellbore and/or reservoir to form the parent organic acid and an alcohol in the wellbore and/or reservoir. Non-limiting examples of esters or di-esters include isomers of methyl formate, ethyl formate, ethylene glycol diformate, α,α-4-trimethyl-3-cyclohexene-1-methylformate, methyl lactate, ethyl lactate, α,α-4-trimethyl 3-cyclohexene-1-methyllactate, ethylene glycol dilactate, ethylene glycol diacetate, methyl acetate, ethyl acetate, α,α,-4-trimethyl-3-cyclohexene-1-methylacetate, dimethyl succinate, dimethyl maleate, di(α,α-4-trimethyl-3-cyclohexene-1-methyl)succinate, 1-methyl-4-(1-methylethenyl)-cyclohexylformate, 1-methyl-4-(1-ethylethenyl)cyclohexylactate, 1-methyl-4-(1-methylethenyl)cyclohexylacetate, di(1-methy-4-(1-methylethenyl)cyclohexyl)succinate.

In some embodiments, the microemulsion comprises a salt. The presence of the salt may reduce the amount of water needed as a carrier fluid, and in addition, may lower the freezing point of the microemulsion. The microemulsion may comprise a single salt or a combination of two or more salts. For example, in some embodiments, the salt comprises a first type of salt and a second type of salt. Non limiting examples of salts include salts comprising K, Na, Br, Cr, Cs, or Li, for example, halides of these metals, including NaCl, KCl, CaCl₂, and MgCl₂.

In some embodiments, the microemulsion comprises a clay stabilizer. The microemulsion may comprise a single clay stabilizer or a combination of two or more clay stabilizers. For example, in some embodiments, the salt comprises a first type of clay stabilizer and a second type of clay stabilizer. Non limiting examples of clay stabilizers include salts above, polymers (PAC, PHPA, etc), glycols, sulfonated asphalt, lignite, sodium silicate, and choline chloride.

In some embodiments, for the formulations above, the other additives are present in an amount between about 0 wt % and about 70 wt %, or between about 1 wt % and about 30 wt %, or between about 1 wt % and about 25 wt %, or between about 1 and about 20 wt %, versus the total microemulsion composition.

In some embodiments, the components of the microemulsion and/or the amounts of the components may be selected so that the microemulsion is stable over a wide-range of temperatures. For example, the microemulsion may exhibit stability between about −40° F. and about 400° F., or between −40° F. and about 300° F., or between about −40° F. and about 150° F. Those of ordinary skill in the art will be aware of methods and techniques for determining the range of stability of the microemulsion. For example, the lower boundary may be determined by the freezing point and the upper boundary may be determined by the cloud point and/or using spectroscopy methods. Stability over a wide range of temperatures may be important in embodiments where the microemulsions are being employed in applications comprising environments wherein the temperature may vary significantly, or may have extreme highs (e.g., desert) or lows (e.g., arctic).

The microemulsions described herein may be formed using methods known to those of ordinary skill in the art. In some embodiments, the aqueous and non-aqueous phases may be combined (e.g., the water and the solvent(s)), followed by addition of a surfactant(s) and optionally other components (e.g., freezing point depression agent(s)) and agitation. The strength, type, and length of the agitation may be varied as known in the art depending on various factors including the components of the microemulsion, the quantity of the microemulsion, and the resulting type of microemulsion formed. For example, for small samples, a few seconds of gentle mixing can yield a microemulsion, whereas for larger samples, longer agitation times and/or stronger agitation may be required. Agitation may be provided by any suitable source, for example, a vortex mixer, a stirrer (e.g., magnetic stirrer), etc.

Any suitable method for injecting the microemulsion (e.g., a diluted microemulsion) into a wellbore may be employed. For example, in some embodiments, the microemulsion, optionally diluted, may be injected into a subterranean formation by injecting it into a well or wellbore in the zone of interest of the formation and thereafter pressurizing it into the formation for the selected distance. Methods for achieving the placement of a selected quantity of a mixture in a subterranean formation are known in the art. The well may be treated with the microemulsion for a suitable period of time. The microemulsion and/or other fluids may be removed from the well using known techniques, including producing the well.

In some embodiments, the emulsion or microemulsion may be prepared as described in U.S. Pat. No. 7,380,606, entitled “Composition and Process for Well Cleaning,” herein incorporated by reference.

For convenience, certain terms employed in the specification, examples, and appended claims are listed here.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “alkane” is given its ordinary meaning in the art and refers to a saturated hydrocarbon molecule. The term “branched alkane” refers to an alkane that includes one or more branches, while the term “unbranched alkane” refers to an alkane that is straight-chained. The term “cyclic alkane” refers to an alkane that includes one or more ring structures, and may be optionally branched. The term “acyclic alkane” refers to an alkane that does not include any ring structures, and may be optionally branched.

The term “alkene” is given its ordinary meaning in the art and refers to an unsaturated hydrocarbon molecule that includes one or more carbon-carbon double bonds. The term “branched alkene” refers to an alkene that includes one or more branches, while the term “unbranched alkene” refers to an alkene that is straight-chained. The term “cyclic alkene” refers to an alkene that includes one or more ring structures, and may be optionally branched. The term “acyclic alkene” refers to an alkene that does not include any ring structures, and may be optionally branched.

The term “aromatic” is given its ordinary meaning in the art and refers to aromatic carbocyclic groups, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
coupling acoustic and/or ultrasonic energy to a fluid stream being injected into an oil and/or gas well, wherein the fluid stream comprises an emulsion or a microemulsion.

2. The method of claim 1, wherein the emulsion or microemulsion comprises water, at least a first type of solvent, and a surfactant.

3. The method of claim 2, wherein the emulsion or microemulsion further comprises a second type of solvent.

4. The method of claim 1, wherein the acoustic and/or ultrasonic energy comprises energy transmitted by waves having a frequency of at least about 20 Hz.

5. The method of claim 1, wherein the acoustic and/or ultrasonic energy comprises energy transmitted by waves having a frequency of at least about 200 Hz.

6. The method of claim 1, wherein the acoustic and/or ultrasonic energy comprises energy transmitted by waves having a frequency of at least about 20 kHz.

7. The method of claim 1, wherein the acoustic and/or ultrasonic energy comprises energy transmitted by waves having a frequency of at least about 100 kHz.

8. The method of claim 1, wherein the fluid stream exerts a pressure of at least about 10 MPa.

9. The method of claim 1, wherein the fluid stream exerts a pressure of at least about 50 MPa.

10. The method of claim 1, wherein the fluid stream exerts a pressure of at least about 100 MPa.

11. The method of claim 1, wherein the fluid stream is an oscillating fluid stream.

12. The method of claim 11, wherein the oscillating fluid stream is a pulsating fluid stream.

13. The method of claim 11, wherein the oscillating fluid stream is a vibrating fluid stream.

14. The method of any preceding claim, wherein the emulsion or microemulsion comprises water, a solvent, and a surfactant

15. The method of claim 14, wherein the emulsion or microemulsion comprises between about 1 wt % and 95 wt % water, or between about 1 wt % and about 90 wt %, or between about 1 wt % and about 60 wt %, or between about 5 wt % and about 60 wt %, or between about 10 wt % and about 55 wt %, or between about 15 wt % and about 45 wt %, versus the total emulsion or microemulsion composition.

16. The method of claim 14, wherein the emulsion or microemulsion comprises between about 2 wt % and 60 wt % solvent, or between 5 wt % and about 40 wt %, or between about 5 wt % and about 30 wt %, versus the total emulsion or microemulsion composition.

17. The method of claim 14, wherein the solvent comprises a terpene.

18. The method of claim 14, wherein the emulsion or microemulsion comprises between about 10 wt % and 60 wt % surfactant, or between about 15 wt % and 55 wt %, or between about 20 wt % and 50 wt %, versus the total emulsion or microemulsion composition

19. The method of claim 14, wherein the emulsion or the microemulsion comprises a first type of surfactant and a second type of surfactant.

20. The method of claim 14, wherein the emulsion or microemulsion comprises a freezing point depression agent.

21. The method as in claim 20, wherein the emulsion or microemulsion comprises between about 0 wt % and about 50 wt %, or between about 0.1 wt % and about 50 wt %, or between about 1 wt % and about 50 wt %, or between about 5 wt % and about 40 wt %, or between about 5 wt % and 35 wt % of the freezing point depression agent versus the total emulsion or microemulsion composition.

22. The method of claim 14, wherein the emulsion or the microemulsion further comprises at least one other additive.
